(19) United States
(12) Patent Application Publication
(10) Pub. No.: US 2007/0220755 A1
(43) Pub. Date: Sep. 27, 2007

(54) Shaving Apparatus

(76) Inventor: Gideon Dror, Ra'anana (IL)

Correspondence Address: EMPK & SHILOH, LLP, 116 JOHN ST,, SUITE 1201, NEW YORK, NY, 10038, US

(21) Appl. No.: 11/596,462

(22) PCT Filed: May 10, 2005
(86) PCT No.: PCT/IL05/00498

§ 371 Date: Nov. 13, 2006

Related U.S. Application Data
(60) Provisional application No. 60/569,609, filed on May 11, 2004.

(51) Int. Cl. B26B 19/16

(52) U.S. Cl. 30/42

(57) ABSTRACT

Embodiments of the invention include a shaving apparatus. The shaving apparatus may include, for example, a generally elongated handle portion; a rotatable blade mechanism coupled to said handle portion and including a generally cylindrical blade mount having mounted thereon a plurality of blades having cutting edges extending radially outwardly from said blade mount; and a rotation mechanism to rotate said blade mount about a rotation axis of said blade mount, wherein the cutting edges are oriented to cut in a shaving plane generally parallel to the rotational axis. Other embodiments are described and claimed.

### FIELD OF THE INVENTION

The invention relates generally to hair cutting and removal devices and, more specifically, to hair shaving devices.

### BACKGROUND

Conventional manual razors include a rod-shaped handle portion and a head portion, which accommodates one or more razor blades to be applied to a shaving surface. This shape has been used for many years, and has been widely considered to be an optimal shape for a convenient shaving experience.

Electric shavers have been later introduced in order to ease the shaving operation. Unfortunately, the shape of existing electric shavers, which may be designed to accommodate robust electrical and mechanical components, may not be optimal for handling by the user.

### SUMMARY OF SOME EMBODIMENTS OF THE INVENTION

Embodiments of the invention include a shaving apparatus.

According to some demonstrative embodiments of the invention, the shaving apparatus may include a generally elongated handle portion. The shaving apparatus may also include a head portion movable with the handle portion and accommodating a rotatable blade mechanism including a generally cylindrical blade mount having mounted thereon a plurality of blades having cutting edges extending generally radially outwardly from the blade mount; and a rotation mechanism to rotate the blade mount about an axis of rotation of the blade mount.

According to some demonstrative embodiments of the invention, the cutting edges may be configured and oriented to cut in a shaving plane generally parallel to the axis of rotation.

### BRIEF DESCRIPTION OF THE DRAWINGS

The invention will be understood and appreciated more fully from the following detailed description of embodiments of the invention, taken in conjunction with the accompanying drawings of which:

FIGS. 1-3 are schematic illustrations of an isometric view, a front view and a side view, respectively of a shaving apparatus according to a demonstrative embodiment of the invention;

FIGS. 4-6 are schematic illustrations of a top view; a cross-sectional side view taken along section lines A-A; and a side view, respectively, of a rotatable blade mechanism according to demonstrative embodiments of the invention;

FIG. 7 is a schematic illustration of a rotation mechanism, which may be implemented by the apparatus of FIGS. 1-3;

FIGS. 8A and 8B are schematic illustrations of a front view and a side view, respectively, of a shaving apparatus according to another demonstrative embodiment of the invention;

FIG. 8C is a schematic illustration of an exploded view of a blade and motor mechanism which may be implemented by the apparatus of FIGS. 8A-8B;

FIG. 8D is a schematic illustration of a rotation-transfer mechanism which may be implemented by the apparatus of FIGS. 8A-8B;

FIG. 9 is an illustration of a “#5 Miniature Motor” produced by Techmax; and

FIG. 10 is a schematic illustration of the blade mechanism of FIGS. 4-6 applied for shaving facial hair.

It will be appreciated that for simplicity and clarity of illustration, elements shown in the figures have not necessarily been drawn accurately or to scale. For example, the dimensions of some of the elements may be exaggerated relative to other elements for clarity or several physical components included in one element. Further, where considered appropriate, reference numerals may be repeated among the figures to indicate corresponding or analogous elements. It will be appreciated that these figures present examples of embodiments of the present invention and are not intended to limit the scope of the invention.

### DETAILED DESCRIPTION OF EMBODIMENTS OF THE INVENTION

In the following description, various aspects of the present invention will be described. For purposes of explanation, specific configurations and details are set forth in order to provide a thorough understanding of the present invention. However, it will be apparent to one skilled in the art that the present invention may be practiced without the specific details presented herein. Furthermore, some features of the invention relying on principles and implementations known in the art may be omitted or simplified to avoid obscuring the present invention.

Some demonstrative embodiments of the invention, may include a shaving apparatus including a rotatable blade mechanism, which may include a generally cylindrical blade mount having mounted thereon a plurality of blades having cutting edges extending generally radially outwardly from the blade mount; and a rotation mechanism to rotate the blade mount about an axis of rotation of the blade mount, wherein the cutting edges may be configured and oriented to cut in a shaving plane generally parallel to the axis of rotation, e.g., as described in detail below.

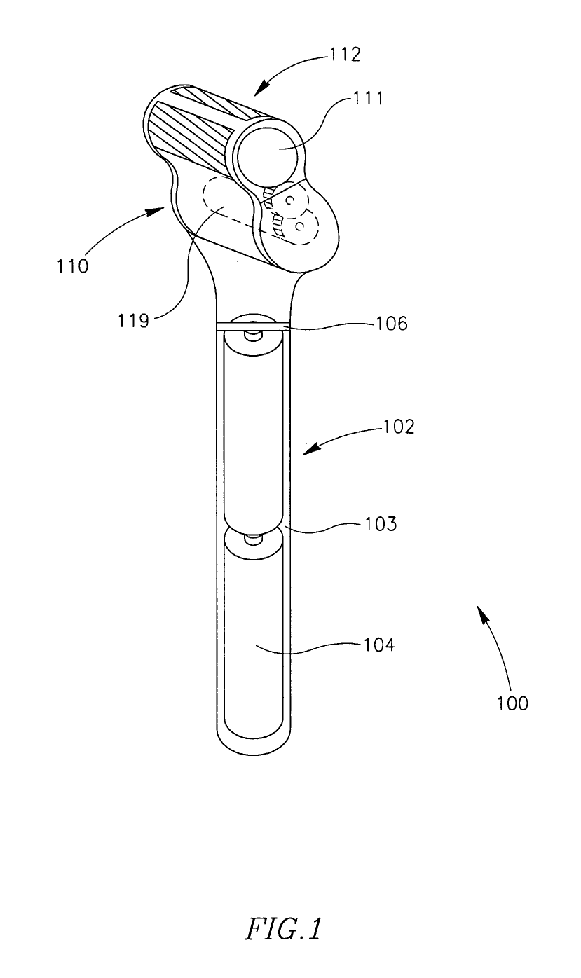

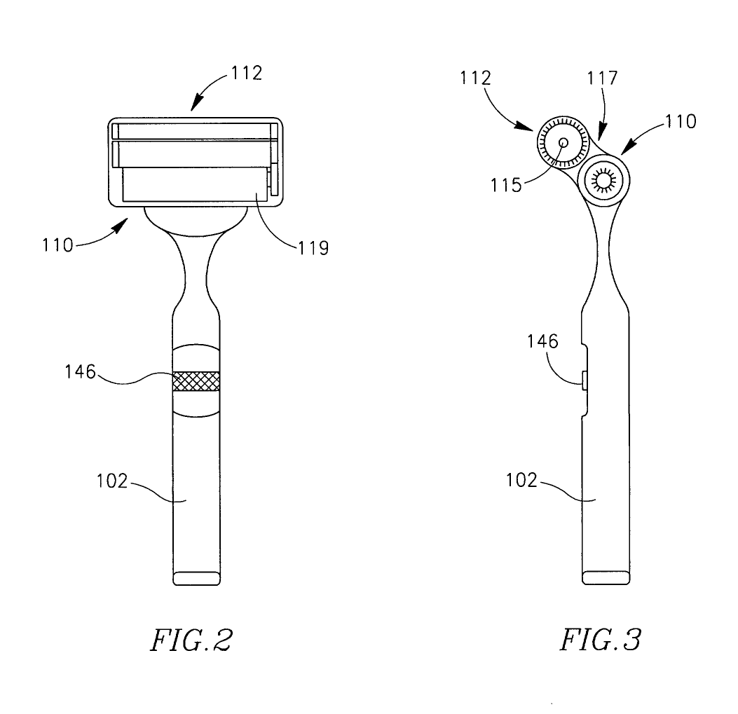

Reference is made to FIGS. 1, 2 and 3, which schematically illustrate an isometric view, a front view and a side view, respectively, of a shaving apparatus 100 according to demonstrative embodiments of the invention.

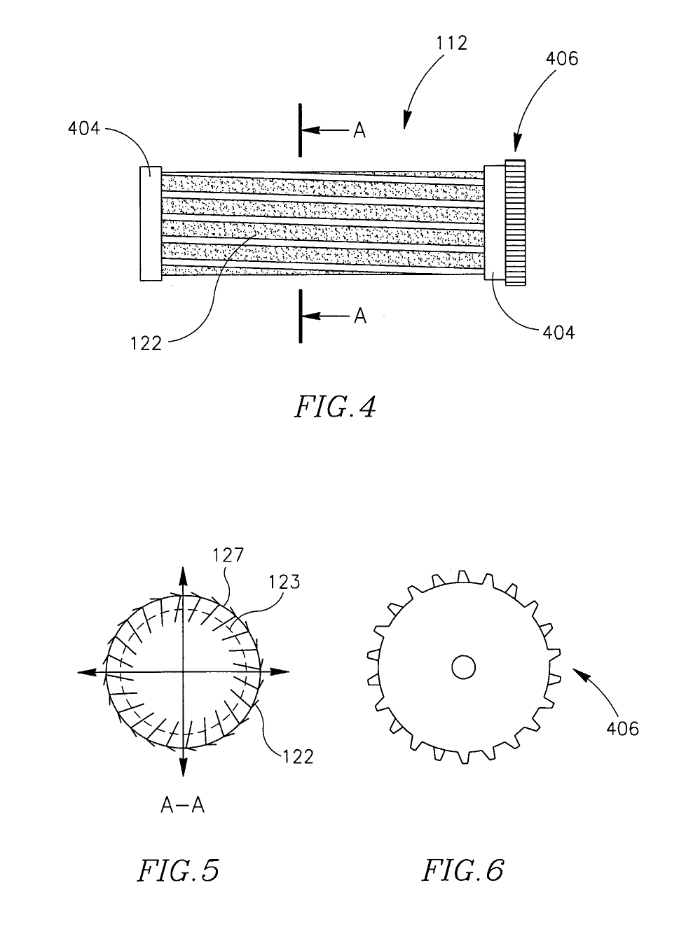

Apparatus 100 may include a handle portion 102, which may have a shape similar to the shape of the handle of a conventional manual shaving device, for example, the type of device used for shaving facial hair, e.g., a beard and/or a mustache, and/or hair growth on other body parts, e.g., legs. For example, handle portion 102 may have a generally elongated and narrow handle-like shape, e.g., adapted to enable a user to comfortably grip portion 102. Apparatus 100 may also include a head portion 117 movable with handle portion 102 and accommodating a rotatable blade mechanism 112. Blade mechanism 112 may include a generally cylindrical blade mount 111 having mounted thereon a plurality of blades 113, e.g., as described below with reference to FIGS. 4-6.

According to some demonstrative embodiments of the invention, apparatus 100 may also include a rotation mechanism 110 to rotate blade mount 111 about an axis of rotation 115 of blade mount 111.

According to some demonstrative embodiments of the invention, apparatus 100 may include one or more housings to accommodate blade mechanism 112 and/or rotation mechanism 110. For example, blade mechanism 112 may be housed within head portion 117, and/or rotation mechanism 110 may be housed within a suitably shaped distal extension of handle portion 102, as shown in FIG. 1 and further described in detail below.

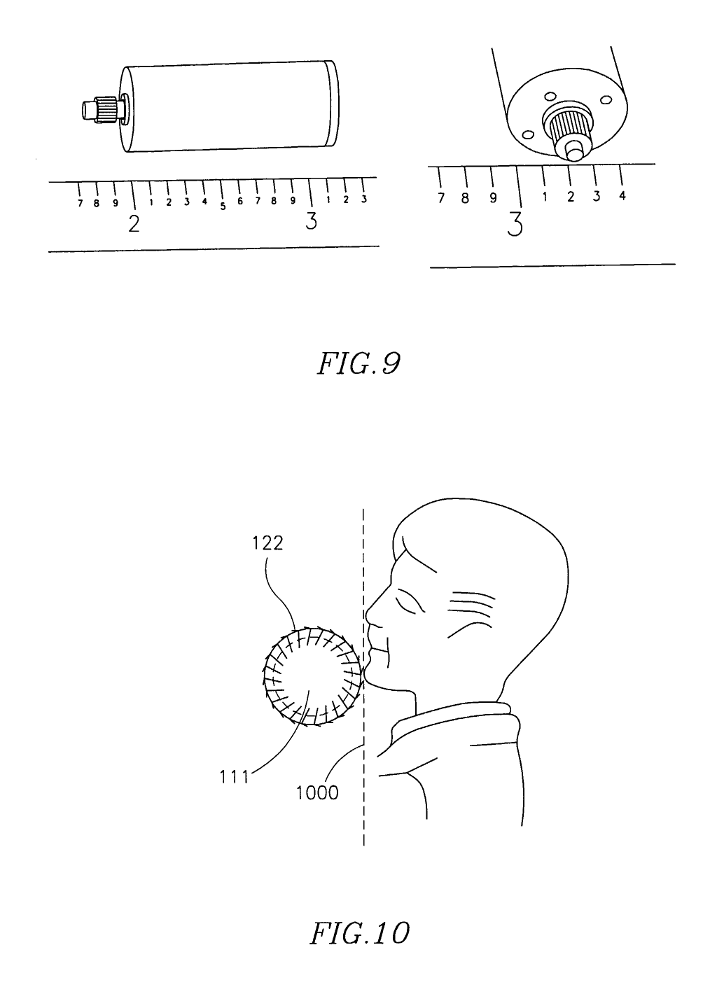

According to demonstrative embodiments of the invention, rotation mechanism 110 may include a rotational motor 119, which may be protected, for example, by a substantially waterproof and/or water resistant container. For example, motor 119 may include a “#5 Miniature Motor” produced by Techmax (www.techmax.com). As shown in FIG. 9, The “#5 Miniature Motor” may have an outer diameter of approximately 0.47″ a length of approximately 1.2″, and a weight of approximately 14 gram. The rotational energy provided by motor 119, when activated, may be used to rotate one or more rotatable parts of blade mechanism 112 at one or more predetermined speeds, which may be selected in accordance with safety and or performance related design requirements, e.g., to accommodate predefined shaving applications, for example, tough beards, sensitive skin, etc. Alternatively, the speed of motor 119 may be continuously variable using a suitable speed control circuit, as is known in the art. For example, the “#5 Miniature Motor” may be activated by a voltage of between 0.35VDC and 3 VDC to rotate at a desired rotational speed, e.g., at a rotational speed of 7,800 RPM and 16,000 RPM when activated by a voltage of 1.5V and 3V, respectively. Motor 119 may be coupled to movable parts of mechanism 112 via a rotation transfer mechanism, which may include one or more shafts, and/or one or more gears, e.g., as described below.

According to demonstrative embodiments of the invention, apparatus 100 may also include an electrical connection configuration, for example, including electrical connections 106, to electrically connect motor 119 with a power source, which may supply the electrical power to operate motor 119. The power source may include, for example, a power storage device, e.g., one or more batteries 104, which may be rechargeable or disposable. The power source may include any other suitable power source adapted to supply electric power to in a current and/or voltage suitable for operation of motor 119, for example, an AC to DC adapter, as is known in the art, to convert electric power supplied from an AC grid to a DC input voltage suitable for operating motor 119.

According to some demonstrative embodiments of the invention, handle portion 102 may include a housing 103 to accommodate the power source, e.g., as shown in FIG. 1.

According to some demonstrative embodiments of the invention, apparatus 100 may also include a switch 146 to allow the user to control operation of motor 119. For example, switch 146 may be electrically connected to the power source and motor 119, e.g., via one or more conductors (not shown) and/or suitable power control circuitry, e.g., as are known in the art. Switch 146 may include, for example, an “on” position and an “off” position and, optionally, multiple speed positions that may activate different modes of an optional speed control circuit.

Reference is also made to FIGS. 4, 5 and 6, which schematically illustrate a top view, a cross-sectional side view taken along section lines AA, and a side view, respectively, of active parts of blade mechanism 112.

According to demonstrative embodiments of the invention, blade mechanism 112 may include a generally cylindrical blade mount 123. A plurality of blades 122, which may have a shape, size and orientation selected according to desired safety and/or performance considerations, may be mounted on mount 123. Blades 122 may have cutting edges extending generally radially outwardly from blade mount 123. Blades 122 may include any suitable blades, e.g., razor blades, as are known in the art. Blade mechanism 112 may be adapted to accommodate any suitable configuration of blades 122 and/or blade mount 123. For example, mechanism 112 may include a predetermined number of blades 122, wherein one or more of blades 122 may extend from an outer surface 127 of blade mount 123 at a predetermined angle related to surface 127 and/or at a predetermined angle related to a plane perpendicular to surface 127. Blade mechanism 112 may also include a gear 406, which may be directly or indirectly coupled to blade mount 123, to enable coupling blade mount 123 to rotation mechanism 110, e.g., via appropriate transmission components, as described below. Blade mechanism 112 may also include, for example, sliding rings 404, e.g., two sliding rings, to secure blade mount 123 at a proper position relative to handle portion 102 and to allow efficient rotation of blade mount 123.

In some demonstrative embodiments, blade mount 123 may be resiliently supported, e.g., using suitable spring elements (not shown) to allow a certain degree of adaptability of apparatus 100 to the particular surface topography of the area being shaved by the user.

As shown in FIG. 10, the cutting edges of blades 122 may be oriented to cut in a shaving plane 1000, which is generally parallel to rotation axis 111.

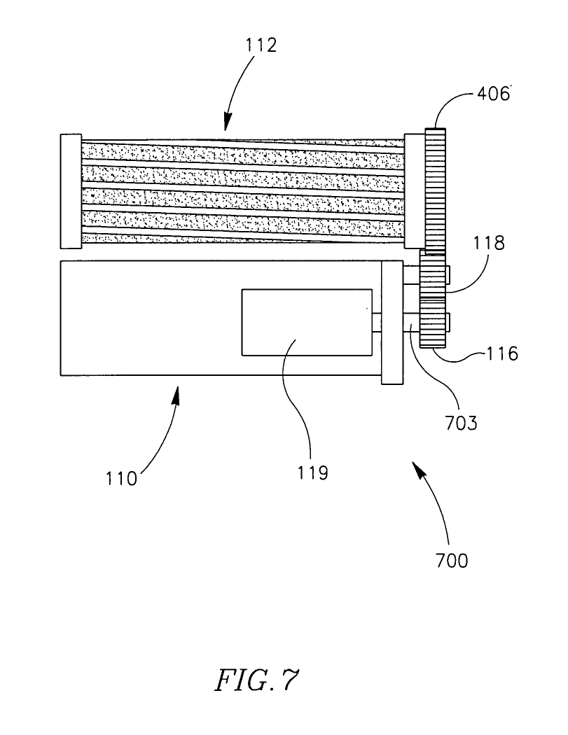

Reference is made to FIG. 7, which schematically illustrates a rotation transfer mechanism 700 for transferring rotational movement from motor 119 to blade mechanism 112, according to a demonstrative embodiment of the invention.

Rotation transfer mechanism 700 may include an output shaft 703 connecting the rotational output of motor 119 to a first transmission gear 116. For example, shaft 703 may have an outer diameter of approximately 0.059″ and a length of approximately 0.18″, e.g., corresponding to the “#5 miniature motor” described above. Mechanism 700 may also include at least one intermediate transmission gear 118 adapted to transfer rotational movement of gear 116 to gear 406 (also shown in FIGS. 4 and 6), at a desired transmission ratio, which may be selected according to the desired speed of blade mechanism 112.

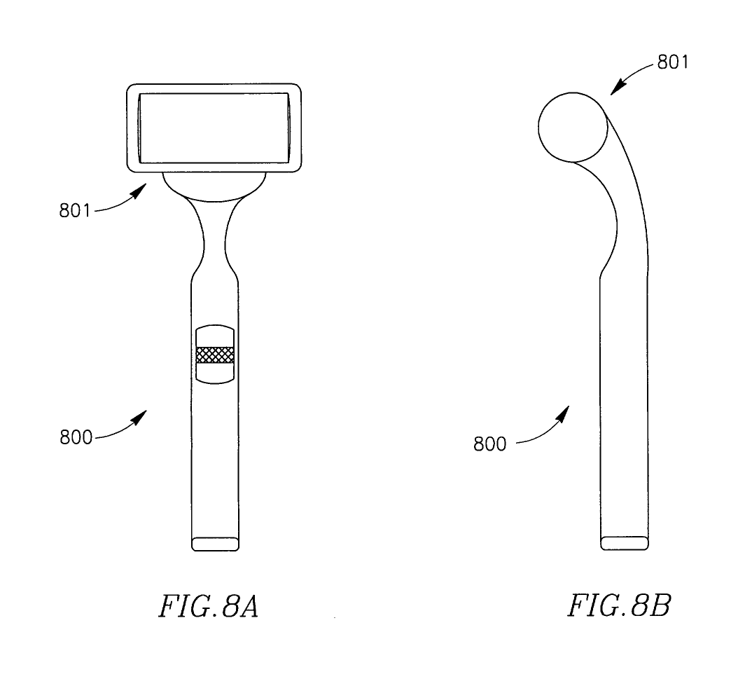

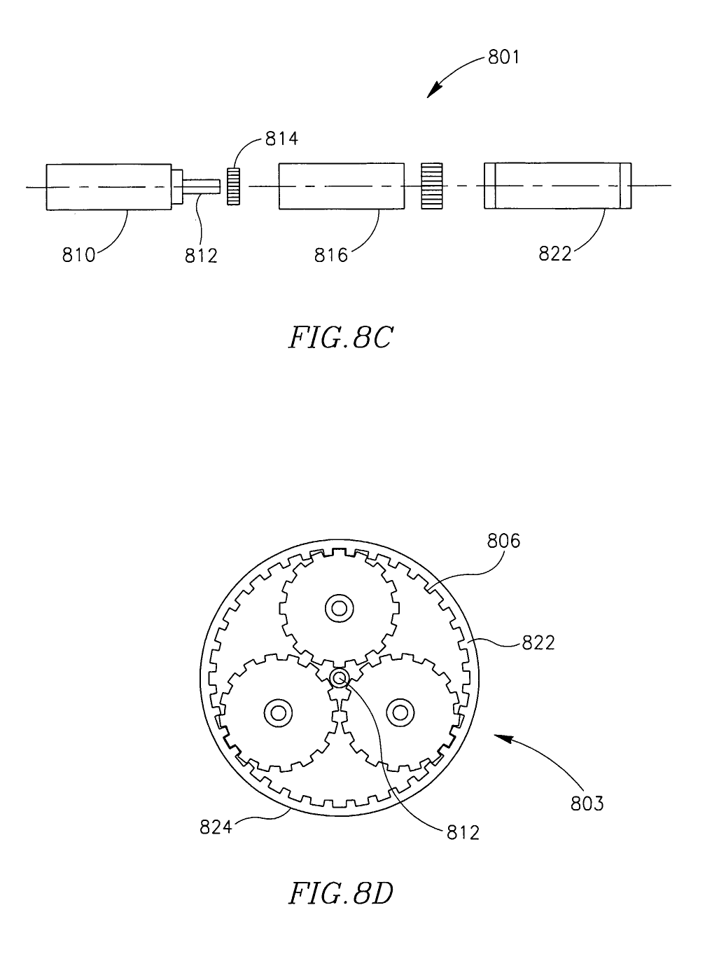

Reference is made to FIGS. 8A and 8B, which schematically illustrate a front view and a side view, respectively, of a shaving apparatus 800 according to another demonstrative embodiment of the invention, and to FIG. 8C, which schematically illustrates an exploded view of a configuration 801, which may be implemented by apparatus 800.

Configuration 801 may include a rotary motor 810, e.g., the “#5 miniature motor” described above, which may be mounted within a motor mount, e.g., a generally cylindrical waterproof mount 816. Configuration 801 may also include a shaft 812 connected to motor 810, and an O-ring 814 which may be fitted over shaft 812, e.g., to “seal” motor 810 within an engine mount 816. Engine mount 816 may be mounted within a blade mechanism 822, which may include a hollow generally cylindrical element having a plurality of blades attached thereon, e.g., in a configuration analogous to the configuration of blade mechanism 112 described above with reference to FIGS. 4-6. Configuration 801 may also include a rotation-transfer mechanism, e.g., including planar gear arrangement as described below, to couple motor 810 to movable parts of blade mechanism 822.

Reference is also made to FIG. 8D, which schematically illustrates a rotation-transfer Mechanism 803, which may be implemented by apparatus 800 according to some demonstrative embodiments.

Mechanism 803 may include a planetary gear transmission having a plurality of “planet” gears, e.g., three gears 824, coupled to shaft 812 and to a mating inner surface 806 of blade mechanism 822. Mechanism 803 may include a configuration, e.g., including a predetermined number of “planet” gears and/or a predetermined gear ratio, adapted to transfer rotational movement of shaft 812 to blade mechanism 822, at a desired transmission ratio.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A shaving apparatus comprising:
a generally elongated handle portion;
a head portion movable with said handle portion and accommodating a rotatable blade mechanism including a generally cylindrical blade mount having mounted thereon a plurality of blades having cutting edges extending generally radially outwardly from said blade mount; and
a rotation mechanism to rotate said blade mount about an axis of rotation of said blade mount,
wherein said cutting edges are configured and oriented to cut in a shaving plane generally parallel to said axis of rotation.

2. The shaving apparatus of claim 1, wherein said plurality of blades extend from said blade mount at a predetermined angle in relation to a radius of said blade mount.

3. The shaving apparatus of claim 1, wherein said rotation mechanism comprises:
a motor having an output shaft; and
a rotation transfer mechanism to transfer rotational movement from said output shaft to said blade mount.

4. The shaving apparatus of claim 3, wherein said rotation transfer mechanism comprises a first gear associated with said shaft, a second gear associated with said blade mount, and one or more transmission gears to transfer rotational movement from said first gear to said second gear at a desired transmission ratio suitable for shaving.

5. The shaving apparatus of claim 4, wherein said first gear is accommodated within said handle portion, and wherein said second gear is accommodated within said head portion.

6. The shaving apparatus of claim 3, wherein said motor is accommodated within said handle portion.

7. The shaving apparatus of claim 3 comprising an electrical connection configuration to electrically connect said motor to a power source.

8. The shaving apparatus of claim 3, wherein said handle portion comprises a housing to accommodate a power source to supply power to said motor.

9. The shaving apparatus of claim 8, wherein said power source comprises one or more batteries.

10. The shaving apparatus of claim 3, wherein said motor is accommodated within said head portion.

11. The shaving apparatus of claim 10, wherein said motor is accommodated within said blade mount.

12. The shaving apparatus of claim 11, wherein said rotation transfer mechanism comprises a planetary gear transmission to transfer rotational movement from said output shaft to said blade mount.

13. The shaving apparatus of claim 1, wherein said rotation mechanism is able to controllably rotate said blade mechanism at one or more predetermined speeds suitable for one or more, respective, shaving applications.
